(19) United States
(12) Patent Application Publication
(10) Pub. No.: US 2010/0315666 A1
(43) Pub. Date: Dec. 16, 2010

(54) HIGH SPEED PAGE TRANSMISSION

(76) Inventor: Yitzhak Lazer, Rishon Lezion (IL)

Correspondence Address: Raymond L. Owens;Patent Legal Staff, Eastman Kodak Company, 343 State Street, Rochester, NY, 14650-2201, US

(21) Appl. No.: 12/482,477

(22) Filed: Jun. 11, 2009

(51) Int. Cl. G06F 3/12

(52) U.S. Cl. 358/1.15

(57) ABSTRACT

An apparatus to transmit data from a digital front end, to a digital printing head. The apparatus includes at least two digital page processing units, a first processing unit (304) and a second processing unit (308). Each of the processing units includes, a frame buffer configured to store digital page data in an intermediate format; a conversion element adapted to convent the digital page data from said intermediate format into a printable format data, and a communication element (344, 348) adapted to transmit the printable format data to a digital printing head for printing. The communication element (344) of the first processing unit (304) is adapted to deliver the first part (312) of the printable format data to said printing head, and the communication element (348) of the second processing unit (308) is adapted to deliver the second part (316) of the printable format data to the printing head.

### CROSS REFERENCE TO RELATED APPLICATIONS

Reference is made to commonly-assigned copending U.S. patent application Ser. No. 11/858,477, filed Sep. 20, 2007, and entitled PARALLEL PROCESSING OF PAGE DESCRIPTION LANGUAGE, by Aronshtam et al., the disclosure of which is incorporated herein.

### FIELD OF THE INVENTION

The present invention relates to supplying data for digitally prepared pages for a high speed digital printing heads.

### BACKGROUND OF THE INVENTION

Digital front ends for color print servers are adapted to prepare data used for driving digital printers. The architecture of such print servers can be described in general terms by two major parts, front end 104 and back end 108, as is depicted in FIG. 1.

Front end 104 receives jobs from a user's desktop computer. The jobs are represented in a digital form of a page description language (PDL) 112, for example, PostScript (PS). The front end 104 processes the job and makes it ready for printing on a digital printing device. The front end element 104 is equipped with PDL processing means, and the output of the processing means is data 116, in a ready-to-print (RTP) form.

Back end element 108 receives the RTP data and sends it to a digital printer for printing via a device interface 120. Most of color print servers produce RTP data buffers in line with the print engine, in other words, the data that is generated by the front end 104 is immediately consumed by the back end 108, skipping a step of generating RTP objects and saving them on an intermediate storage, such as RTP storage 224, shown in FIG. 2, for further printing. One line of commercial color print services uses the above method of intermediate RTP generation, and defines a special RTP format and a data flow based on the RTP format. The RTP format consists of reusable as well as non-reusable elements, which are represented as separate RTP elements.

Front end 104 receives incoming PDL jobs in, for example, a page definition file (PDF), PostScript (PS), or variable PostScript (VPS). Front end 104 processes the jobs, and converts the PDL to RIP jobs. Back end 108 merges and assembles the RTP elements into page-bitmaps and outputs the bitmaps to the printer using a device interface 120.

The use of intermediate saved RTP format is effective for meeting the digital printer's engine speed. For non-variable data printing (VDP) jobs, multiple copies are printed at the engine speed. This is achieved by preparing the RTP once and printing the RTP multiple times. In the case of typical VDP jobs, the RTP is prepared at engine speed.

The strict division between the front end and the back end elements when designing an interface to a new printer is a very important. The front end is a printer-independent part and typically requires limited customization, while the back end is a printer-dependent part and typically requires specific customization to accommodate individual printer needs. FIG. 2 is a top-level view of a typical commercial color print server illustrating the separation between the front end 104 and the back end 108 as discussed above.

An important element in the printer color server architecture is the merger and printer interface boards 232. A merger-board merges and assembles RTP elements in real-time at the engine speed. The rest of the system can be viewed as a production line and its main purpose is to produce a plurality of RTP object in order to feed the merger-boards. This view of the system is convenient, however, other alternative views are possible as well.

According to this RTP format, a ripped job consists of RTP pages and each page refers to RTP elements. RTP is an element-based format and rendered reusable and non-reusable elements are represented as separate RTP elements. Each RTP element can be viewed as a compressed raster-element. RTP is prepared accordingly to accommodate the specifics of the fusion cards and engine characteristics.

Processing front end 104, shown in FIG. 2, consists of the following main components:
1. Job input 208, responsible for importing jobs to the system, often via a spool disk 204.
2. Raster image processor (RIP) 212.
3. Image processing components 216 for transformations of raster data produced by RIP 212.
4. RTP preparation module 220.

As described above, the front end 104 receives incoming PDL jobs 112 and converts them to RTP format 116. PDL-to-RTP is a multi-step operation that consists of the following processing steps:
1. The job is received and imported to the system.
2. The job is scheduled for processing.
3. The pipelined job processing starts at RIP 212 followed by image processing 216 such as trapping and anti-aliasing.
4. RTP preparation module 220 transforms the final raster-data to RTP format 116.
5. RTP format 116 is further stored at RTP storage 224.

All the above steps are performed in pipelined fashion. For example, trapping may start after a few raster scanlines are RIPed and RTP creation may start after a few raster scanlines on the page are prepared.

Printing back end 108 consists of the following components:
1. RTP storage 224—an efficient raster-element storage that guarantees reading of raster-elements at print engine speed. RTP storage is typically implemented as a fast disk or a disk-array. This enables a large storage capacity at high-speeds as dictated by the engine speed.
2. Data feeder 228—a component that schedules work for merger card/cards. It is responsible for loading RTP layout, initiating merge operations, and monitoring merge process.
3. Merger boards 232—the components responsible for merging and assembling RTP elements into final page-bitmaps and sending said bitmaps to the print engine.

The main operations performed by the back end are the operations of merging and assembling of RTP data to the resulting bitmaps. Though the merging process can be implemented either in software or in hardware, typically the merger is implemented in hardware in order to meet printer engine speed.

According to the performance requirements, there could be a single merger board or multiple merger boards in the system. In a printer color server equipped with a single merger board 232, the board will handle all the process colors (e.g. Cyan (C), Magenta (M), Yellow (Y) and Black (K)). In a printer color server equipped with multiple merger boards each board can be responsible for one or more process colors. For example, in the case of two merger boards 232, one board will handle C and M color channels and the other board will handle Y and K colors.

The requirements of color digital printers are getting more and more demanding. Printers capable of printing one hundred A4 color pages per minute (100 ppm) are already available. Printers that will print more than 1000 ppm will be introduced in the near future. The upcoming high speed printers pose a technical challenge, for handling and delivering high volume data in relatively small time intervals.

### SUMMARY OF THE INVENTION

Briefly, according to one aspect of the present invention, there is provided a system for data transmission from a digital front end to a digital printing head including at least two digital page processing units (a first processing unit and a second processing unit). Each processing units includes, a frame buffer configured to store digital page data in an intermediate format, a conversion element adapted to convent the digital page data from the intermediate format into a printable format data. A communication element is adapted to transmit the printable format data to a digital printing head for printing. The communication element of the first processing unit delivers the first part of the printable format data to the printing head, and the communication element of the second processing unit delivers the second part of the printable format data to the printing head.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “Figure”), wherein:

FIG. 1 is a prior art schematic of front end and back end elements in a digital printer architecture;

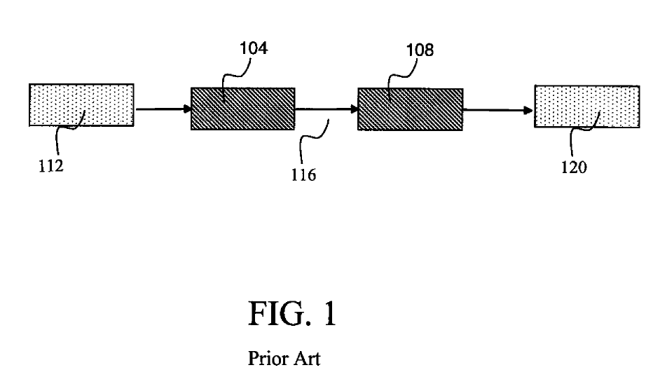

FIG. 2 is a prior art illustration showing a top-level view of a typical commercial color print server illustrating the separation between the front end and the back end elements;

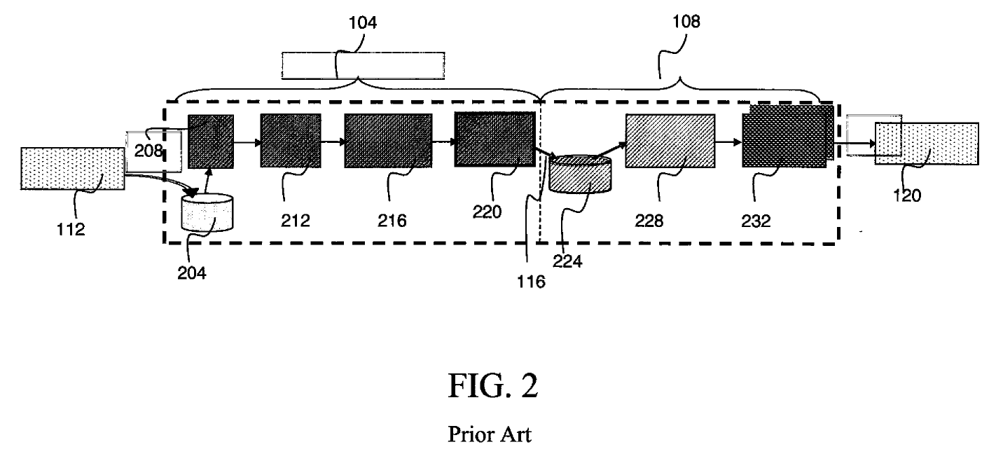

FIG. 3 is schematic illustration showing two page processors sharing each others fiber optic communication element; and

FIG. 4 is a schematic illustration showing data composition comprising of left and right side of a page delivered to digital printing expose elements.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

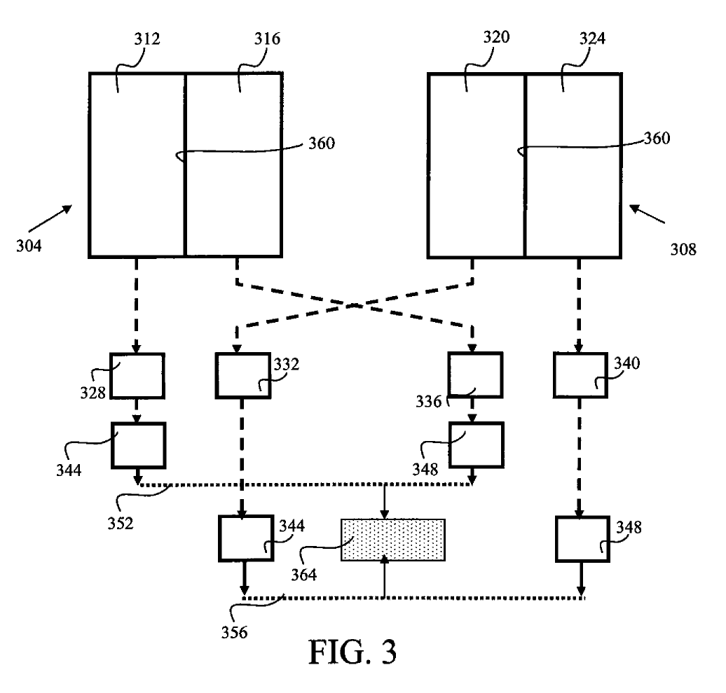

FIG. 3 shows a configuration of two page processors boards 304 and 308, wherein each page processor is adapted to process a different PDL page, usually fetched from RTP storage 224. The page processors 304 and 308 have functionality similar to the previously described merger and printer interface boards 232.

Each of the processors 304 and 308 work on distinct pages. Processor 304 prepares page (a) for printing, while processor 308 prepares page (n+1), to be printed following to page (n) on the time scale.

In one embodiment of this invention, two processors 304 and 308 are deployed in order to process page (n), followed by page (n+1). This is required, due to the high volume data handling demanded to meet the speed requirement of the high speed printers. Processor 304 and 308 will process page (n) and page (n+1) respectively. The processed pages (n and n+1) are divided into: page (n) left side 312 (PNL), page (n) right side 316 (PNR), page (n+1) left side 320 (PN1L) and page (n+1) right side 324 (PN1R).

The created pages (n) and (n+1) are to be delivered to the digital printer heads for printing. The current invention uses processor 308 for right side of page (n) 316, and the left side of page (n) 312 is delivered by processor 304. Following to that, page (n+1) will be delivered as follows: the left side of page 320 to processor 304 and the right side to processor 308. This method offers more efficient utilization of processors means, enabling on time data delivery to the high speed printers.

For better understanding the proposed method the data delivery will be described in more detail. Processor 304 transfers page (n) left side data 312 into FIFO First In First Out buffer) 328, and page (n) right side data 316 into FIFO 336 of processor 308. Fiber optic component 344 (of processor 304) will deliver data from FIFO 328, and fiber optic component 348 (of processor 308) will deliver data from FIFO 336 to the printing head, to form combined data 352 for page (n), and will be delivered to printer 364. The combined data 356, representing page (n+1), will be formed and delivered to printer 364 in a similar fashion. The left side of page (n+1) 320 and right side of page (n+1) 324 will be delivered, using FIFO's 332 and 340 respectively.

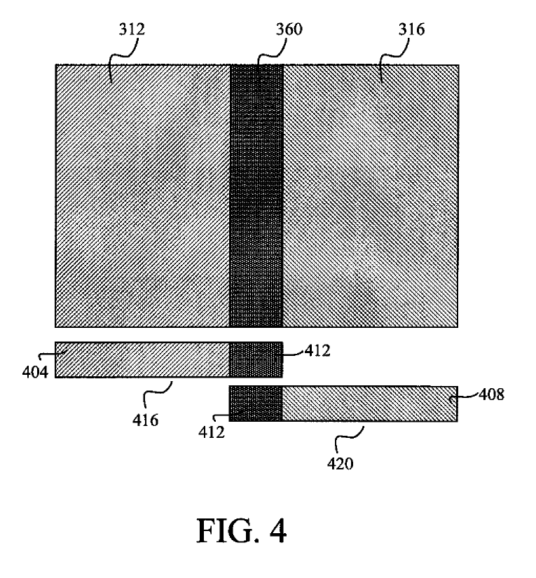

FIG. 4 shows a schematic view illustrating page data composition including left 312 and right 316, and a common area 360 (stitching area) comprised of the data bordering left and right sides (312, 316) of a page. Left side 312, common area 360, and right side 316 is delivered to the exposing head to buffers 404, 412, 408 respectively. Left side printing head 416 will fetch the data from buffer 404 and common buffer 412, whereas the right side printing head 420 will fetch the data from buffer 408 and from common buffer 412.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

### PARTS LIST

104 front end
108 back end
112 page description language (PDL) job
116 ready to print (RTP) format
120 device interface
204 spool disk
208 input
212 raster image processor (RIP)
216 image processing components
220 RTP preparation module
224 RTP storage
228 data feeder
232 merger and printer interface boards
304 page n processor
308 page n+1 processor
312 page n left side (PNL)
316 page n right side (PNR)
320 page n+1 left side (PN1L)
324 page n+1 right side (PN1R)
328 FIFO for PNR
332 FIFO for PNL
336 FIFO for PN1L
340 FIFO for PN1R
344 fiber optic component of page n processor
348 fiber optic component of page n+1 processor
352 page n data delivered by 344 and 348 to expose heads
356 page n+1 data delivered by 344 and 348 to expose heads
360 stitching region
364 printer
404 data of left side of page n
408 data of right side of page n
412 data of common section (stitched area) containing most right pixels of left page side with most left pixels of right page side
416 left side printing head data containing left page side with appended stitched area on its right
420 right side printing head data containing right page side with appended stitched area on its left

1. An apparatus for transmission of data from a digital front end to a digital printing head comprising of at least a first digital page processing unit and a second digital page processing unit wherein each of said at least two processing units comprises:
a frame buffer configured to store digital page data in an intermediate format;
a conversion element adapted to convent said digital page data from said intermediate format into a printable format data;
a communication element adapted to transmit said printable format data to said digital printing head for printing; and
wherein the communication element of said first processing unit is adapted to deliver a first part of said printable format data to said printing head, and the communication element of said second processing unit is adapted to deliver a second part of said printable format data to said printing head.

2. The apparatus according to claim 1 wherein said communication element is a fiber optic communication element.

3. The apparatus according to claim 1 wherein said first part of said printable format data includes a portion of said second part of said printable format data.

4. The apparatus according to claim 1 wherein said second part of said printable format data includes a portion of said first part of said printable format data.
